(19) United States
(12) Patent Application Publication
(10) Pub. No.: US 2020/0099657 A1
(43) Pub. Date: Mar. 26, 2020

(54) SECURE RECOVERY FROM A REPLAY PROTECTION LIST CONDITION

(71) Applicant: QUALCOMM Incorporated, San Diego, CA (US)

(72) Inventors: Chirag Manojkumar Kharvar, Bangalore (IN); Sourabh Jana, Bangalore (IN); Jagdeep Kumar Hans, Bangalore (IN)

(21) Appl. No.: 16/136,602

(22) Filed: Sep. 20, 2018

(51) Int. Cl. H04L 29/12; H04L 29/06; H04L 5/00; H04W 12/12

(52) U.S. Cl. CPC H04L 61/6009; H04L 63/1466; H04L 5/0055; H04W 4/80; H04L 63/164; H04L 63/126; H04W 12/12

(57) ABSTRACT

Methods, systems, and devices for secure recovery from full replay protection lists are described. The method includes receiving, at a second device from a first device in a wireless mesh network, a first message indicating that a replay protection list (RPL) of the first device has reached a defined capacity, determining whether the first device is configured with a fixed RPL or a dynamic RPL based on the first message or a provisioning message received before the first message, sending, from the second device, a second message indicating at least one of an increase of a capacity of the RPL or a set of source addresses to be included in or removed from the RPL based on determining whether the first device is configured with the fixed RPL or dynamic RPL, and receiving, from the first device, an indication that the RPL has been updated based on the second message.

### BACKGROUND

The following relates generally to wireless communications, and more specifically to recovery from a replay protection list condition.

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a wireless local area network (WLAN), such as a Wi-Fi (i.e., Institute of Electrical and Electronics Engineers (IEEE) 802.11) network may include an access point (AP) that may communicate with one or more wireless or mobile devices. The AP may be coupled to a network, such as the Internet, and may enable a mobile device to communicate via the network (or communicate with other devices coupled to the access point). A wireless device may communicate with a network device bi-directionally. For example, in a WLAN, a device may communicate with an associated AP via downlink (e.g., the communication link from the AP to the device) and uplink (e.g., the communication link from the device to the AP). A wireless personal area network (PAN), which may include a Bluetooth connection, may provide for short range wireless connections between two or more paired wireless devices. For example, wireless devices such as cellular phones may utilize wireless PAN communications to exchange information such as audio signals with wireless headsets.

In some cases, wireless communications may be constrained to provide enhanced quality of service. For example, successful bidirectional transmission of audio information for voice communications may have a relatively low tolerance for packet loss or timing issues. The link quality between two devices may affect the data rate used for communications (e.g., as poor link quality may be associated with reduced bitrates for more robust communications). Improved techniques for wireless communications are desired.

### SUMMARY

The described techniques relate to improved methods, systems, devices, and apparatuses that support secure recovery from a replay protection list condition. Generally, the described techniques provide for secure recovery from full replay protection lists (RPLs). When an RPL of a first device has reached a defined capacity (e.g., is nearly full or is full), the first device may be blocked from handling packets from a second device (e.g., when a source address of the second device is not already present in the RPL). In some cases, a device may maliciously fill the RPL of the first device to cause malfunction or performance degradation. The present techniques provide recovery from an RPL that has reached a defined capacity based on the configuration of the first device.

A method of secure recovery from full replay protection lists is described. The method may include receiving, from a first device in a wireless mesh network at a second device in the wireless mesh network, a first message indicating that a replay protection list (RPL) of the first device has reached a defined capacity, determining whether the first device is configured with a fixed RPL or a dynamic RPL based on the first message or a provisioning message received before the first message, sending, from the second device, a second message indicating at least one of an increase of a capacity of the RPL or a set of source addresses to be included in or removed from the RPL based on determining whether the first device is configured with the fixed RPL or the dynamic RPL, and receiving, from the first device, an indication that the RPL has been updated based on the second message.

An apparatus for secure recovery from full replay protection lists is described. The apparatus may include a processor, memory in electronic communication with the processor, and instructions stored in the memory. The instructions may be executable by the processor to cause the apparatus to receive, from a first device in a wireless mesh network at a second device in the wireless mesh network, a first message indicating that a replay protection list (RPL) of the first device has reached a defined capacity, determine whether the first device is configured with a fixed RPL or a dynamic RPL based on the first message or a provisioning message received before the first message, send, from the second device, a second message indicating at least one of an increase of a capacity of the RPL or a set of source addresses to be included in or removed from the RPL based on determining whether the first device is configured with the fixed RPL or the dynamic RPL, and receive, from the first device, an indication that the RPL has been updated based on the second message.

Another apparatus for secure recovery from full replay protection lists is described. The apparatus may include means for receiving, from a first device in a wireless mesh network at a second device in the wireless mesh network, a first message indicating that a replay protection list (RPL) of the first device has reached a defined capacity, determining whether the first device is configured with a fixed RPL or a dynamic RPL based on the first message or a provisioning message received before the first message, sending, from the second device, a second message indicating at least one of an increase of a capacity of the RPL or a set of source addresses to be included in or removed from the RPL based on determining whether the first device is configured with the fixed RPL or the dynamic RPL, and receiving, from the first device, an indication that the RPL has been updated based on the second message.

A non-transitory computer-readable medium storing code for secure recovery from full replay protection lists is described. The code may include instructions executable by a processor to receive, from a first device in a wireless mesh network at a second device in the wireless mesh network, a first message indicating that a replay protection list (RPL) of the first device has reached a defined capacity, determine whether the first device is configured with a fixed RPL or a dynamic RPL based on the first message or a provisioning message received before the first message, send, from the second device, a second message indicating at least one of an increase of a capacity of the RPL or a set of source addresses to be included in or removed from the RPL based on determining whether the first device is configured with the fixed RPL or the dynamic RPL, and receive, from the first device, an indication that the RPL has been updated based on the second message.

Some examples of the method, apparatuses, and non-transitory computer-readable medium described herein may further include operations, features, means, or instructions for configuring the second message to indicate the set of source addresses to be included in a whitelist of the RPL based on determining the first device may be configured with the fixed RPL configuration.

Some examples of the method, apparatuses, and non-transitory computer-readable medium described herein may further include operations, features, means, or instructions for identifying one or more source addresses included in entries of the RPL based on determining the first device may be configured with the dynamic RPL configuration, where sending the second message may be based on identifying the one or more source addresses.

Some examples of the method, apparatuses, and non-transitory computer-readable medium described herein may further include operations, features, means, or instructions for determining, based on the one or more source addresses indicated in the first message, whether the RPL includes one or more entries to be excluded from the RPL, where sending the second message may be based on determining whether the RPL includes one or more entries to be excluded from the RPL.

Some examples of the method, apparatuses, and non-transitory computer-readable medium described herein may further include operations, features, means, or instructions for identifying a quantity of entries to be excluded from the RPL based on the set of source addresses indicated in the second message and determining whether the quantity of entries to be excluded from the RPL satisfies a determined threshold.

Some examples of the method, apparatuses, and non-transitory computer-readable medium described herein may further include operations, features, means, or instructions for configuring the second message to indicate the set of source addresses to be included in the RPL based on determining the quantity of entries to be excluded from the RPL satisfies the determined threshold.

Some examples of the method, apparatuses, and non-transitory computer-readable medium described herein may further include operations, features, means, or instructions for configuring the second message to indicate the increase to the capacity of the RPL based on determining the quantity of entries to be excluded from the RPL may be less than the determined threshold.

Some examples of the method, apparatuses, and non-transitory computer-readable medium described herein may further include operations, features, means, or instructions for receiving a negative-acknowledgement message from the first device indicating that a capacity of a memory of the first device prevents the increase to the capacity of the RPL.

Some examples of the method, apparatuses, and non-transitory computer-readable medium described herein may further include operations, features, means, or instructions for configuring the second message to indicate the set of source addresses to be included in the whitelist of the RPL based on receiving the negative-acknowledgement message from the first device.

Some examples of the method, apparatuses, and non-transitory computer-readable medium described herein may further include operations, features, means, or instructions for receiving an acknowledgement message from the first device indicating that a capacity of a memory of the first device permits the increase to the capacity of the RPL and updating configuration information of the first device based on the increase to the capacity of the RPL, where the configuration information may be stored remotely from the first device.

### BRIEF DESCRIPTION OF THE DRAWINGS

FIG. 1 illustrates an example of a system that supports secure recovery from a replay protection list condition in accordance with aspects of the present disclosure.

FIG. 2 illustrates an example of a system that supports secure recovery from a replay protection list condition in accordance with aspects of the present disclosure.

FIG. 3 illustrates an example of a data flow diagram that supports secure recovery from a replay protection list condition in accordance with aspects of the present disclosure.

FIG. 4 illustrates an example of a message format that supports secure recovery from a replay protection list condition in accordance with aspects of the present disclosure.

FIGS. 5 and 6 show block diagrams of devices that support secure recovery from a replay protection list condition in accordance with aspects of the present disclosure.

FIG. 7 shows a block diagram of a replay protection manager that supports secure recovery from a replay protection list condition in accordance with aspects of the present disclosure.

FIG. 8 shows a diagram of a system including a device that supports secure recovery from a replay protection list condition in accordance with aspects of the present disclosure.

FIGS. 9 and 10 show flowcharts illustrating methods that support secure recovery from a replay protection list condition in accordance with aspects of the present disclosure.

### DETAILED DESCRIPTION

The present techniques describe using custom messages to allow a provisioning device to manage the set of addresses a device is allowed to include in its replay protection list. The following relates generally to replay lists (RPLs) in a mesh network (e.g., Bluetooth mesh network). Specifically, when an RPL is full or when another condition exists, a device may be blocked from handling packets from a device with a source address that is not already present in the RPL. In addition to occurring under normal operating conditions, the RPL condition (e.g., the RPL being full) may occur as a result of an impersonation attack. When a malicious device artificially fills a device's RPL, the device may be blocked from communicating with any new device with a source address that is not already present in the device's RPL.

The present techniques provide recovery from the one or more RPL conditions in different ways based on the RPL configuration of the device. A device may be configured with a fixed RPL, which may not be modified by the device, or may be configured with a dynamic RPL, which may be modified by the device (e.g., a device may be configured to increase capacity of its RPL at run time, etc.).

When a device determines that its RPL meets a condition (e.g., determines that its RPF is full), the device may send a message (e.g., an RPL FULL message) to a provisioner. Upon receiving the RPL FULL message from the device, the provisioner may query a database to determine whether the database includes information regarding a configuration of the device. Upon identifying details regarding the configuration of the device in the database, the provisioner may determine whether the device is configured with a dynamic RPL or a fixed RPL. In some cases, the device may communicate details regarding its configuration to the provisioner. For example, the device may send a separate message to the provisioner indicating the device is configured with a dynamic RPL or a fixed RPL or such information may be included in a message sent with other related information.

In some cases, the RPL FULL message may include at least some if not all of the source addresses of entries currently in the RPL of the device. In some cases, the provisioner may determine whether the source addresses currently in the RPL of the device (e.g., provided in the RPL FULL message) are allowed to be in the RPL of the device.

In one example, the provisioner may query the database to determine which source addresses are allowed in the RPL of the device and/or which source addresses are not allowed in the RPL of the device. For example, in some cases, the database may include a list of source addresses allowed in the RPL of the device. Additionally or alternatively, the database may include a list of source addresses not allowed in the RPL of the device. In some cases, based on the query of the database, the provisioner may identify one or more source addresses currently in the RPL of the device as allowed source addresses. Additionally or alternatively, based on the query of the database, the provisioner may identify one or more source addresses currently in the RPL of the device as prohibited source addresses.

After receiving the RPL FULL message, the provisioner may determine that the device is configured with a fixed RPL. When the provisioner determines the device is configured with a fixed RPL, the provisioner may send an RPL update message to the device. In some cases, the RPL update message may include a list of source addresses. In some cases, the device may add the source addresses in the RPL update message to a permitted list (e.g., a whitelist). In one example, the RPL update message may instruct the device to add the sources addresses to a whitelist of the device. Alternatively, the device may be pre-configured to add the sources addresses to a whitelist.

In some cases, additionally or alternatively, the device may update its RPL based on the source addresses in the whitelist. For example, the RPL may determine whether a source address of an entry currently in its RPL is on the whitelist. In some cases, the device may permit the entry to remain in the RPL upon determining the source address is on the whitelist. Alternatively, the device may remove the entry upon determining the source address is not on the whitelist.

When the provisioner determines that the device is configured with a dynamic RPL, the provisioner may determine how many of the source addresses currently in the RPL of the device are prohibited source addresses. In some cases, the provisioner may compare the quantity of prohibited source addresses currently in the RPL of the device to a threshold. When the provisioner determines that the quantity of prohibited source addresses currently in the RPL of the device satisfies the threshold, which may be a predetermined or preconfigured threshold, (e.g., there are more prohibited source address in the RPL than allowed source addresses), the provisioner may send the RPL update message to the device in order to remove the prohibited source addresses from the RPL. When the provisioner determines the quantity of prohibited source addresses currently in the RPL of the device does not exceed the threshold (e.g., more allowed source address in the RPL than prohibited source addresses), the provisioner may send an RPL increase message.

In some cases, the RPL increase message may indicate an increase to a capacity of the RPL of the device beyond a predefined or default capacity. As one example, the RPL increase message may instruct the device to increase the RPL capacity from a first value (e.g., 5 entries) to a second value (e.g., 10 entries). Accordingly, after reaching the original limit of 5 entries, the device may increase the capacity to 10 entries, enabling the device to receive 5 additional entries.

In some cases, the threshold may be a fixed value. For example, the threshold may be set at a value of 5. Accordingly, when the quantity of entries not allowed in the RPL is greater than 5 (or greater than or equal to 5), then the provisioner may send a message instructing the device which source addresses are to be included in a whitelist of the RPL and to drop any entry currently in the RPL with a source address that does not appear or exist on the whitelist. Conversely, when the quantity of entries not allowed in the RPL is less than 5 (or less than or equal to 5), then the provisioner may send a message instructing the device to increase a capacity of the RPL. In some cases, the threshold may be a percentage or a ratio. In one example, the threshold may be set at a percentage of 50%. Thus, when the quantity of entries not allowed in the RPL is greater than 50% of a capacity of the RPL (or greater than or equal to 50% of the capacity), then the provisioner may send a message instructing the device which source addresses are to be included in a whitelist of the RPL and to drop entries with non-matching source addresses. Conversely, when the quantity of entries not allowed in the RPL is less than 50% of the capacity of the RPL (or less than or equal to 50% of the capacity), then the provisioner may send a message instructing the device to increase a capacity of the RPL.

In some cases, the device may determine whether a memory of the device permits the device to increase the capacity of the RPL. When the device determines that the memory allows for the increase to the capacity, the device may send an acknowledgment message to the provisioner. When the provisioner receives the acknowledgment message, the provisioner may update a configuration of the device to indicate the updated capacity. Conversely, when the device determines that the memory or another component does not permit the increase to the capacity, the device may send a negative-acknowledgment message to the provisioner. In some cases, the provisioner may send a message to the device to increase the capacity as much as the memory availability allows upon receiving the negative-acknowledgment message. In such a case, the device may send a message to the provisioner indicating the new capacity of the device (e.g., how many new entries were added to the capacity, a new total capacity, etc.). Additionally or alternatively, the provisioner may send the provisioner may send an RPL update message to the device upon receiving the negative-acknowledgment message. In some cases, the device may add the source addresses in the RPL update message to a whitelist and update the RPL accordingly.

Aspects of the disclosure are initially described in the context of a wireless communications system. The present techniques provide operations and functions of wireless systems for secure recovery from full replay protection lists. Aspects of the disclosure are further illustrated by and described with reference to apparatus diagrams, system diagrams, and flowcharts that relate to secure recovery from a replay protection list condition.

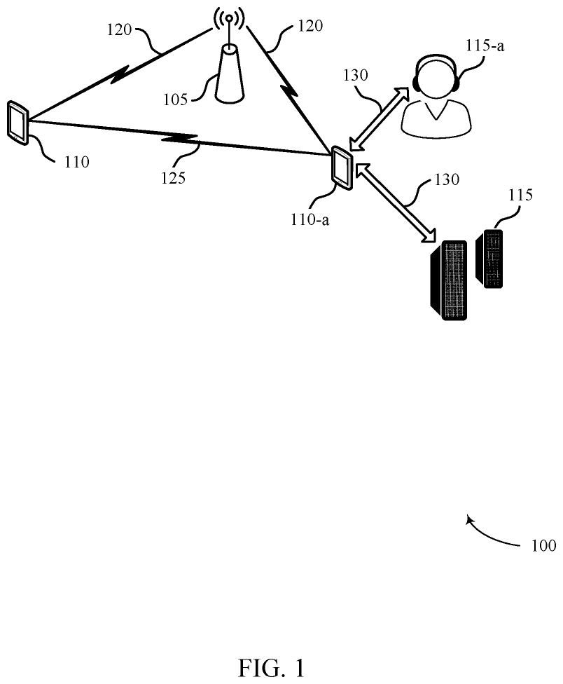

FIG. 1 illustrates a system 100 (e.g., which may include to refer to or include a wireless personal area network (PAN), a wireless local area network (WLAN), a Wi-Fi network) configured in accordance with various aspects of the present disclosure. The system 100 may include an AP 105, devices 110, and paired devices 115 implementing WLAN communications (e.g., Wi-Fi communications) and/or Bluetooth communications. For example, devices 110 may include cell phones, mobile stations, personal digital assistant (PDAs), other handheld devices, netbooks, notebook computers, tablet computers, laptops, or some other suitable terminology. Paired devices 115 may include Bluetooth devices capable of pairing with other Bluetooth devices (e.g., such as devices 110), which may include wireless headsets, speakers, ear pieces, headphones, display devices (e.g., TVs, computer monitors), microphones, meters, valves, etc.

Bluetooth communications may refer to a short-range communication protocol and may be used to connect and exchange information between devices 110 and paired devices 115 (e.g., between mobile phones, computers, digital cameras, wireless headsets, speakers, keyboards, mice or other input peripherals, and similar devices). Bluetooth systems (e.g., aspects of wireless communications system 100) may be organized using a master-slave relationship employing a time division duplex protocol having, for example, defined time slots of 625 mu secs, in which transmission alternates between the master device (e.g., a device 110) and one or more slave devices (e.g., paired devices 115). In some cases, a device 110 may generally refer to a master device, and a paired device 115 may refer to a slave device in a PAN. As such, in some cases, a device may be referred to as either a device 110 or a paired device 115 based on the Bluetooth role configuration of the device. That is, designation of a device as either a device 110 or a paired device 115 may not necessarily indicate a distinction in device capability, but rather may refer to or indicate roles held by the device in the PAN. Generally, device 110 may refer to a wireless communication device capable of wirelessly exchanging data signals with another device, and paired device 115 may refer to a device operating in a slave role, or to a short-range wireless device capable of exchanging data signals with the mobile device (e.g., using Bluetooth communication protocols).

A Bluetooth device may be compatible with certain Bluetooth profiles to use desired services. A Bluetooth profile may refer to a specification regarding an aspect of Bluetooth-based wireless communications between devices. That is, a profile specification may refer to a set of instructions for using the Bluetooth protocol stack in a certain way, and may include information such as suggested user interface formats, particular options and parameters at each layer of the Bluetooth protocol stack, etc. For example, a Bluetooth specification may include various profiles that define the behavior associated with each communication endpoint to implement a specific use case. Profiles may thus generally be defined according to a protocol stack that promotes and allows interoperability between endpoint devices from different manufacturers through enabling applications to discover and use services that other nearby Bluetooth devices may be offering. The Bluetooth specification defines device role pairs that together form a single use case called a profile. One example profile defined in the Bluetooth specification is the Handsfree Profile (HFP) for voice telephony, in which one device implements an Audio Gateway (AG) role and the other device implements a Handsfree (HF) device role. Another example is the Advanced Audio Distribution Profile (A2DP) for high-quality audio streaming, in which one device (e.g., device 110-a) implements an audio source device (SRC) role and another device (e.g., paired device 115-a) implements an audio sink device (SNK) role.

For a commercial Bluetooth device that implements one role in a profile to function properly, another device that implements the corresponding role must be present within the radio range of the first device. For example, in order for an HF device such as a Bluetooth headset to function according to the Handsfree Profile, a device implementing the AG role (e.g., a cell phone) must be present within radio range. Likewise, in order to stream high-quality mono or stereo audio according to the A2DP, a device implementing the SNK role (e.g., Bluetooth headphones or Bluetooth speakers) must be within radio range of a device implementing the SRC role (e.g., a stereo music player).

The Bluetooth specification defines a layered data transport architecture and various protocols and procedures to handle data communicated between two devices that implement a particular profile use case. For example, various logical links are available to support different application data transport requirements, with each logical link associated with a logical transport having certain characteristics (e.g., flow control, acknowledgement/repeat mechanisms, sequence numbering, scheduling behavior, etc.). The Bluetooth protocol stack is split in two parts: a “controller stack” containing the timing critical radio interface, and a “host stack” dealing with high level data. The controller stack is generally implemented in a low cost silicon device containing the Bluetooth radio and a microprocessor. The controller stack may be responsible for setting up links 130 such as asynchronous connection-less (ACL) links, synchronous connection orientated (SCO) links, etc. Further, the controller stack may implement link management protocol (LMP) functions, low energy link layer (LE LL) functions, etc. The host stack is generally implemented as part of an operating system, or as an installable package on top of an operating system. The host stack may be responsible for logical link control and adaptation protocol (L2CAP) functions, Bluetooth network encapsulation protocol (BNEP) functions, service discovery protocol (SDP) functions, etc. In some cases, the controller stack and the host stack may communicate via a host controller interface (HCI). In other cases, (e.g., for integrated devices such as Bluetooth headsets), the host stack and controller stack may be run on the same microprocessor to reduce mass production costs. For such “hostless systems,” the HCI may be optional, and may be implemented as an internal software interface.

A link 130 established between two Bluetooth devices (e.g., between a device 110-a and a paired device 115-a) may provide for communications or services (e.g., according to some Bluetooth profile). For example, a Bluetooth connection may be an extended synchronous connection orientated (eSCO) link for voice call (e.g., which may allow for retransmission), an ACL link for music streaming (e.g., A2DP), etc. For example, eSCO packets may be transmitted in predetermined time slots (e.g., 6 Bluetooth slots each for eSCO). The regular interval between the eSCO packets may be specified when the Bluetooth link is established. The eSCO packets to/from a specific slave device (e.g., paired device 115-a) are acknowledged, and may be retransmitted if not acknowledged during a retransmission window. In addition, audio may be streamed between the device 110-a and paired device 115-a using an ACL link (A2DP profile). In some cases, the ACL link may occupy 1, 3, or 5 Bluetooth slots for data or voice. Other Bluetooth profiles supported by Bluetooth devices may include Bluetooth Low Energy (BLE) (e.g., providing considerably reduced power consumption and cost while maintaining a similar communication range), human interface device profile (HID) (e.g., providing low latency links with low power requirements), etc.

In some cases, a device may be capable of both Bluetooth and WLAN communications. For example, WLAN and Bluetooth components may be co-located within a device, such that the device may be capable of communicating according to both Bluetooth and WLAN communication protocols, as each technology may offer different benefits or may improve user experience in different conditions. In some cases, Bluetooth and WLAN communications may share a same medium, such as the same unlicensed frequency medium. In such cases, a device 110 may support WLAN communications via AP 105 (e.g., over communication links 120). The AP 105 and the associated devices 110 may represent a basic service set (BSS) or an extended service set (ESS). The various devices 110 in the network may be able to communicate with one another through the AP 105. In some cases the AP 105 may be associated with a coverage area, which may represent a basic service area (BSA).

Devices 110 and APs 105 may communicate according to the WLAN radio and baseband protocol for physical and MAC layers from IEEE 802.11 and versions including, but not limited to, 802.11b, 802.11g, 802.11a, 802.11n, 802.11ac, 802.11ad, 802.11ah, 802.11ax, etc. In other implementations, peer-to-peer connections or ad hoc networks may be implemented within system 100. AP 105 may be coupled to a network, such as the Internet, and may enable a device 110 to communicate via the network (or communicate with other devices 110 coupled to the AP 105). A device 110 may communicate with a network device bi-directionally. For example, in a WLAN, a device 110 may communicate with an associated AP 105 via downlink (e.g., the communication link from the AP 105 to the device 110) and uplink (e.g., the communication link from the device 110 to the AP 105).

In some examples, content, media, audio, etc. exchanged between a device 110 and a paired device 115 may originate from a WLAN. For example, in some cases, device 110-a may receive audio from an AP 105 (e.g., via WLAN communications), and the device 110-a may then implement the described techniques to relay or pass the audio to the paired device 115-a (e.g., via Bluetooth communications). In some cases, certain types of Bluetooth communications (e.g., such as high quality or high definition (HD) Bluetooth) may require enhanced quality of service. For example, in some cases, delay-sensitive Bluetooth traffic may have higher priority than WLAN traffic.

One or more of devices 105, 110, and 115 of FIG. 1 may include a replay protection manager configured to provide secure recovery from one or more replay protection conditions, such as a full replay protection list. In some cases, the replay protection manager may detect when a replay protection list approaches and/or reaches its full capacity and perform one or more operations to identify prohibited and/or malicious entries in the replay protection list and remove the prohibited and/or malicious entries to allow source addresses of legitimate devices to be added to the replay protection list, and further preventing the prohibited and/or malicious entries from blocking the source addresses of legitimate devices to be added to the replay protection list. In some cases, at least one of AP 105, a device 110, and a paired device 115 are just some examples of means for performing at least some of the functions described herein.

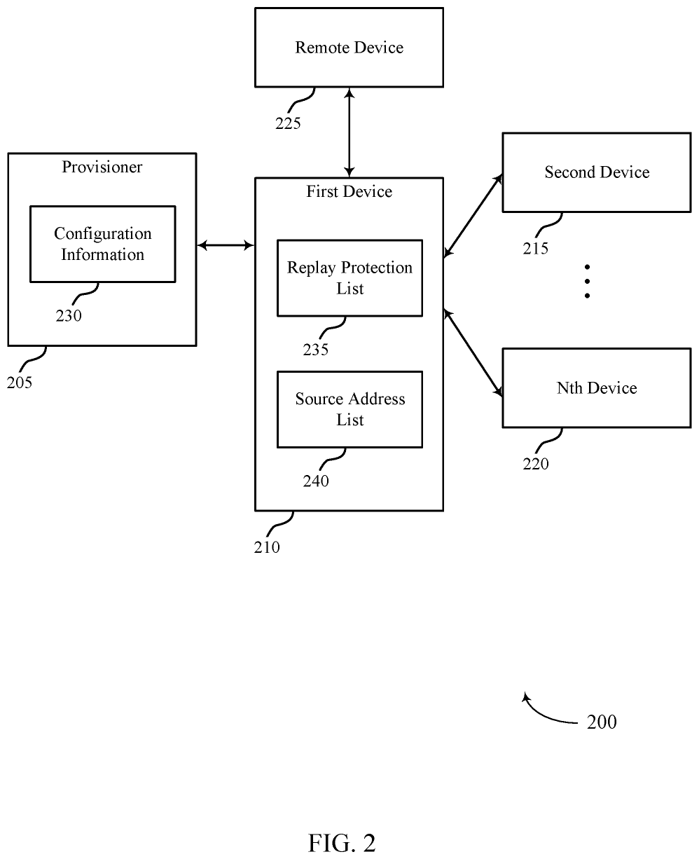

FIG. 2 illustrates a data flow diagram 200 that supports secure recovery from full replay protection lists in accordance with aspects of the present disclosure. In some examples, data flow diagram 200 may implement aspects of a wireless communication system such as system 100 of FIG. 1. As shown, data flow diagram 200 may include provisioner 205, first device 210, second device 215 to Nth device 220 (e.g., N is a positive integer greater than 2), and remote device 225. Examples of provisioner 205, first device 210, second device 215 to Nth device 220, and/or remote device 225 may include at least one of a computing device (e.g., desktop, laptop, etc.), a mobile computing device (e.g., smart phone, tablet, etc.), control panel, sensor device (e.g., motion sensor, light sensor, audio sensor, camera sensor, door sensor, window sensor, etc.), sensor server, device server, automation device (automated light switch, automated door lock, automated thermostat, etc.), automated and/or networked home appliance (e.g., oven, stove, microwave, refrigerator, furnace, air conditioner, etc.), a data networking device, or any combination thereof.

In the illustrated example, provisioner 205 may include configuration information 230. In some cases, provisioner 205 may include or connect to a storage medium (e.g., storage drive, memory, cloud storage, internal database, external database, etc.). In some examples, provisioner 205 may store configuration information 230 in the storage medium.

In some cases, first device 210 may include a replay protection list (RPL) 235 and a source address list 240. In some cases, at least one of provisioner 205, second device 215 to Nth device 220, and remote device 225, or any combination thereof, may include a RPL, which may have similar characteristics to or be similar to RPL 235. In some cases, RPL 235 may include one or more entries associated with devices in communication with first device 210. In one example, first device 210 and second device 215 may be associated with the same software application. In some cases, the software application may be associated with an application key. In one example, first device 210 may communicate with second device 215 in conjunction with operations of the software application. In some cases, first device 210 may add information associated with second device 215 to an entry in RPL 235 in conjunction with the communications between first device 210 and second device 215. In some cases, the information added to the entry of RPL 235 may include a source address of second device 215 and a sequence value. In some cases, second device 215 may increment a sequence value each time second device 215 sends a message to first device 210.

For example, second device 215 may send first device 210 a first message with a first sequence value and a second message with a second sequence value, where the second sequence value is greater than the first sequence value. Upon receiving the second message and determining the second sequence value is greater than the first sequence value, first device 210 may update the entry of RPL 235 associated with the second device 215. For example, first device 210 may replace the first sequence value stored in the entry with the second sequence value.

In one example, RPL 235 may have a finite quantity of entries and when each entry is filled, RPL 235 may be considered full. In some cases, second device 215 may initiate communications with first device 210 after RPL 235 is full. When first device 210 receives a message from second device 215 and RPL 235 is full, first device 210 may reject communications with second device 215.

For example, first device 210 may determine that there is no available entry in which to add a sequence and source address from second device 215. Accordingly, first device 210 may disregard messages from second device 215 as long as RPL 235 remains full. In some cases, a malicious device may fill entries of RPL 235 with fake information. For example, remote device 225 may receive an application key of an application associated with first device 210 and use this application key to fill one or more entries of RPL 235 with fake sequences and/or fake source addresses. In some cases, remote device 225 may fill at least one entry with a sequence and/or source address of remote device 225.

In one example, first device 210 may send a message to provisioner 205 upon determining RPL 235 is full. For example, first device 210 may send a full-RPL message to provisioner 205. When provisioner 205 receives the message from first device 210, provisioner 205 may query configuration information 230 to determine which source addresses are allowed to be added to RPL 235 and/or which source addresses are not allowed to be added to RPL 235. In some cases, provisioner 205 may send a reply message to first device 210. In some cases, the reply message may indicate one or more source addresses permitted to be added to RPL 235 and/or one or more source addresses not allowed to be added to RPL 235. In some cases, first device 210 may add the one or more source addresses allowed to be added to RPL 235 to a whitelist (e.g., a list of devices permitted to be added to RPL 235 based at least in part on a configuration of first device 210) and/or one or more source addresses not allowed to be added to RPL 235 to a blacklist (e.g., a list of devices prohibited from being added to RPL 235 based at least in part on a configuration of first device 210). In some cases, source address list 240 may include a list of one or more source addresses allowed to be added to RPL 235 and/or a list of one or more source addresses not allowed to be added to RPL 235. Thus, in some cases source address list 240 may include a whitelist and/or a blacklist associated with RPL 235.

Upon receiving the reply message from provisioner 205, first device 210 may analyze the source addresses in RPL 235 in relation to the source addresses in the reply message. In some cases, first device 210 may clear out one or more entries from RPL 235 (e.g., delete information in the entry, refresh the entry, etc.) as a result of the information in the reply message. For example, first device 210 may clear an entry of RPL 235 upon determining that a source address in the entry is not included in the list of source addresses allowed to be added to RPL 235. Alternatively, may clear an entry of RPL 235 upon determining that a source address in the entry is included in the list of source addresses not allowed to be added to RPL 235. In some cases, first device 210 may keep information previously stored in an entry of RPL 235 upon determining that a source address in the entry is included in the list of source addresses allowed to be added to RPL 235. In some cases, first device 210 may keep information previously stored in an entry of RPL 235 upon determining that a source address in the entry is not included in the list of source addresses prohibited from being added to RPL 235

In one example, after clearing out at least one entry from RPL 235, second device 215 may send a message to first device 210. For example, second device 215 may send one or more messages that are rejected, and then send an additional message after one or more entries of RPL 235 are cleared out. Alternatively, second device 215 may initiate communications with first device 210 after one or more entries of RPL 235 are cleared out. Accordingly, when first device 210 receives the message from second device 215 and at least one entry of RPL 235 is open or available (e.g., the entry is empty, no data in the entry, etc.), first device 210 may accept communications with second device 215 by adding a sequence and/or source address of second device 215 to an open entry. Accordingly, the present techniques may enable first device 210 to prevent malicious filling of RPL 235 and prevent rejection of communications with legitimate devices. In some cases, at least one of first device 210, provisioner 205, and second device 215 are some examples of means for performing at least some of the functions described herein.

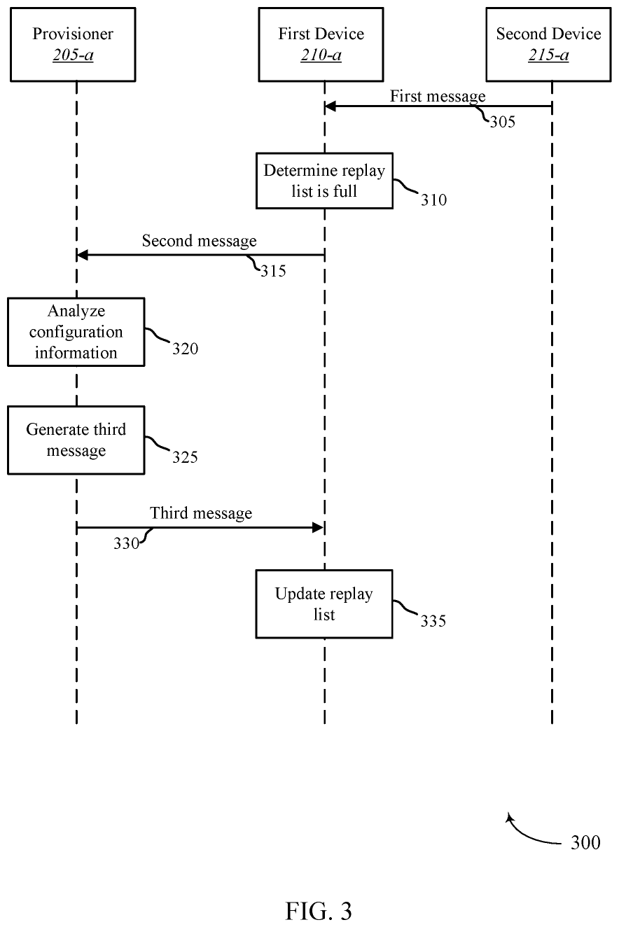

FIG. 3 illustrates a data flow diagram 300 that supports secure recovery from full replay protection lists in accordance with aspects of the present disclosure. In some examples, data flow diagram 300 may implement aspects of a wireless communication system such as system 100 of FIG. 1.

At 305, second device 215-a sends a first message to first device 210-a. In some cases, the first message may include an identifier associated with second device 215-a. For example, the first message may include a device identifier or source address indicating the second device 215-a is sending the first message. In some cases, the first message from second device 215-a may include a payload that includes a request for data from first device 210-a, data for second device 215-a, and/or commands from second device 215-a.

At block 310, first device 210-a may determine that its replay protection list has reached a threshold (e.g., is full, is approaching being full). For example, upon receiving the first message at 305, first device 210-a may analyze its replay protection list to determine whether the replay protection list includes a quantity of one or more open entries for second device 215-a. At 315, first device 210-a may send a second message to provisioner 205-a. The second message may indicate that the replay protection list of first device 210-a has reaches a threshold (e.g., is full, is approaching being full). In some cases, the threshold may be based at least in part on a defined capacity such as a percentage value (e.g., triggered upon determining the RPL is 90% full, triggered upon determining the RPL is 100% full) or a set value (e.g., triggered upon determining 7 out of 10 available slots in the RPL are full, triggered upon determining 10 out of 10 available slots are full).

At block 320, provisioner 205-a may analyze configuration information associated with first device 210-a. In one example, provisioner 205-a may analyze the configuration information to determine which devices may be associated with the replay protection list of first device 210-a. Additionally or alternatively, provisioner 205-a may analyze the configuration information to determine which devices are not be associated with the replay protection list of first device 210-a. In one example, the configuration information may include a list of source addresses of devices that may be added to entries of the replay protection list of first device 210-a and/or may include a list of source addresses of devices that may not be added to entries of the replay protection list of first device 210-a.

At block 325, provisioner 205-a may generate a third message based at least in part on the analysis of the configuration information. In one example, the third message of block 325 may indicate one or more source addresses allowed to be added to an RPL of first device 210-a. Additionally or alternatively, the third message of block 325 may indicate one or more source addresses to be blocked from being added to the RPL of first device 210-a. Additionally or alternatively, the third message of block 325 may indicate a request to increase a capacity of the RPL of first device 210-a. At 330, provisioner 205-a may send the third message to first device 210-a.

At block 335, first device 210-a may update its replay protection list based at least in part on the information included in the third message. For example, the first device 210-a may remove one or more addresses in the replay protection list based on the information from the third message. Additionally or alternatively, the first device 210-a may add one or more addresses indicated in the third message to a whitelist associated with the replay protection list. In some cases, the first device 210-a may add one or more addresses indicated in the third message to a blacklist associated with the replay protection list. The depicted operations of data flow diagram 300 improve the operations of at least first device 210-a by enabling first device 210-a to recover from a full RPL based on the configuration of first device 210-a.

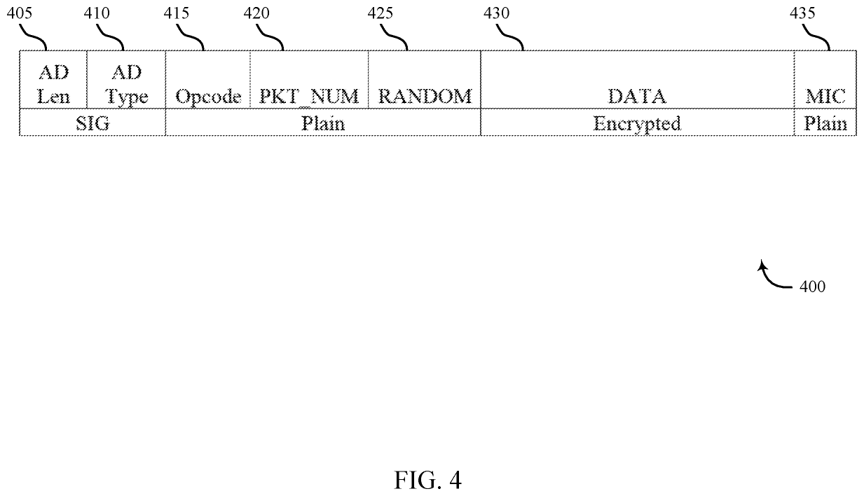

FIG. 4 illustrates an example of a message format 400 that supports secure recovery from full replay protection lists in accordance with aspects of the present disclosure. In some examples, message format 400 may implement aspects of a wireless communication system such as system 100.

As illustrated, message format 400 includes a length field 405, type field 410, operation code field 415, a packet number field 420, a random value field 425, a data field 430, and a message integrity check (MIC) field 435. In some cases, the length field 405 may indicate a length of information associated with a message (e.g., a length of a payload in data field 430 or an overall length of a payload in multiple data fields in a sequence of messages, etc.). In some cases, the type field 410 may indicate a type of information associated with a message (e.g., a type of payload in data field 430, etc.).

In one example, operation code field 415 may indicate a type of command passed in a message of message format 400. In some cases, packet number field 420 may indicate a packet number in a sequence of packets (e.g., in case of a segmented packet, packet number field 420 may represent a segment number in a sequence of packets). In one example, packet number field 420 may hold one or more zeroes (e.g., all zeroes) when a single packet is being sent. In one example, random value field 425 may include a random value associated with a particular request. In some cases, a request may be associated with one or more messages. Thus, in some cases each message associated with the same request may include the same random value in random value field 425. In some cases, the random value may be used to calculate nonce.

In one example, data field 430 may include a payload of a message. In one example, a payload of a message may include one or more source addresses (e.g., source addresses present in a device's RPL, source addresses allowed to be associated with a particular device according to configuration information of the particular device, etc.). In one embodiment, data field 430 may include up to 8 source addresses. When an RPL includes more than 8 source addresses, a sequence of at least two messages may be sent. For example, an RPL with 10 source addresses may result in a first message with 8 of the 10 messages (e.g., the first 8 messages in the RPL), and a second message with 2 of the 10 messages (e.g., the last 2 messages in the RPL).

In some cases, MIC field 435 may include information to enable a computing device to perform a message integrity check to determine whether data in a message is accurate and can be trusted or whether data in the message is missing and/or corrupted. In one example, length field 405 may include 1 byte, type field 410 may include 2 bytes, operation code field 415 may include 1 byte, packet number field 420 may include 1 byte, random value field 425 may include 4 bytes, data field 430 may include 16 bytes, and message integrity check (MIC) field 435 may include 8 bytes.

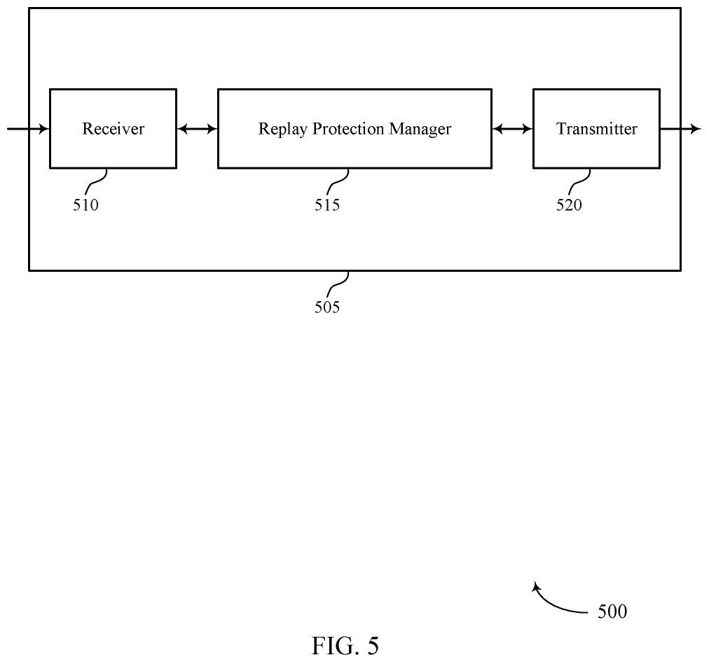

FIG. 5 shows a block diagram 500 of a device 505 that supports secure recovery from a replay protection list condition in accordance with aspects of the present disclosure. The device 505 may be an example of aspects of a device as described herein. The device 505 may include a receiver 510, a replay protection manager 515, and a transmitter 520. The device 505 may also include a processor. Each of these components may be in communication with one another (e.g., via one or more buses).

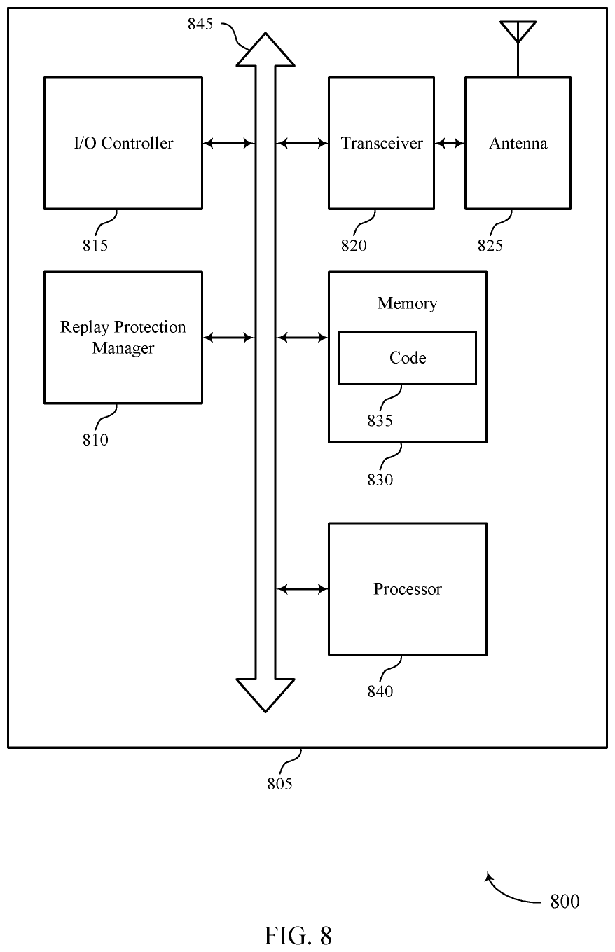

The receiver 510 may receive information such as packets, user data, or control information associated with various information channels (e.g., control channels, data channels, and information related to secure recovery from a replay protection list condition, etc.). Information may be passed on to other components of the device 505. The receiver 510 may be an example of aspects of the transceiver 820 described with reference to FIG. 8. The receiver 510 may utilize a single antenna or a set of antennas.

The replay protection manager 515 may receive, from a first device in a wireless mesh network at a second device in the wireless mesh network, a first message indicating that a replay protection list (RPL) of the first device has reached a defined capacity, send, from the second device, a second message indicating at least one of an increase of a capacity of the RPL or a set of source addresses to be included in or removed from the RPL based on determining whether the first device is configured with the fixed RPL or the dynamic RPL, receive, from the first device, an indication that the RPL has been updated based on the second message, and determine whether the first device is configured with a fixed RPL or a dynamic RPL based on the first message or a provisioning message received before the first message. The replay protection manager 515 may be an example of aspects of the replay protection manager 810 described herein.

The replay protection manager 515, or its sub-components, may be implemented in hardware, code (e.g., software or firmware) executed by a processor, or any combination thereof. If implemented in code executed by a processor, the functions of the replay protection manager 515, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The replay protection manager 515, or its sub-components, may be physically located at various positions, including being distributed such that portions of functions are implemented at different physical locations by one or more physical components. In some examples, the replay protection manager 515, or its sub-components, may be a separate and distinct component in accordance with various aspects of the present disclosure. In some examples, the replay protection manager 515, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 520 may transmit signals generated by other components of the device 505. In some examples, the transmitter 520 may be collocated with a receiver 510 in a transceiver module. For example, the transmitter 520 may be an example of aspects of the transceiver 820 described with reference to FIG. 8. The transmitter 520 may utilize a single antenna or a set of antennas.

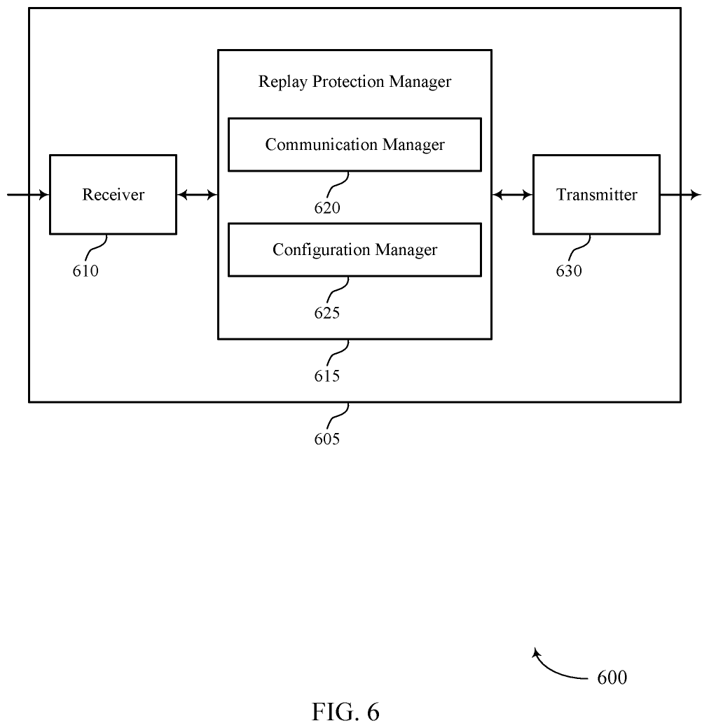

FIG. 6 shows a block diagram 600 of a device 605 that supports secure recovery from a replay protection list condition in accordance with aspects of the present disclosure. The device 605 may be an example of aspects of a device 505 or a device 115 as described herein. The device 605 may include a receiver 610, a replay protection manager 615, and a transmitter 630. The device 605 may also include a processor. Each of these components may be in communication with one another (e.g., via one or more buses).

The receiver 610 may receive information such as packets, user data, or control information associated with various information channels (e.g., control channels, data channels, and information related to secure recovery from a replay protection list condition, etc.). Information may be passed on to other components of the device 605. The receiver 610 may be an example of aspects of the transceiver 820 described with reference to FIG. 8. The receiver 610 may utilize a single antenna or a set of antennas.

The replay protection manager 615 may be an example of aspects of the replay protection manager 515 as described herein. The replay protection manager 615 may include a communication manager 620 and a configuration manager 625. The replay protection manager 615 may be an example of aspects of the replay protection manager 810 described herein.

The communication manager 620 may receive, from a first device in a wireless mesh network at a second device in the wireless mesh network, a first message indicating that a replay protection list (RPL) of the first device has reached a defined capacity, send, from the second device, a second message indicating at least one of an increase of a capacity of the RPL or a set of source addresses to be included in or removed from the RPL based on determining whether the first device is configured with the fixed RPL or the dynamic RPL, and receive, from the first device, an indication that the RPL has been updated based on the second message.

The configuration manager 625 may determine whether the first device is configured with a fixed RPL or a dynamic RPL based on the first message or a provisioning message received before the first message.

The transmitter 630 may transmit signals generated by other components of the device 605. In some examples, the transmitter 630 may be collocated with a receiver 610 in a transceiver module. For example, the transmitter 630 may be an example of aspects of the transceiver 820 described with reference to FIG. 8. The transmitter 630 may utilize a single antenna or a set of antennas.

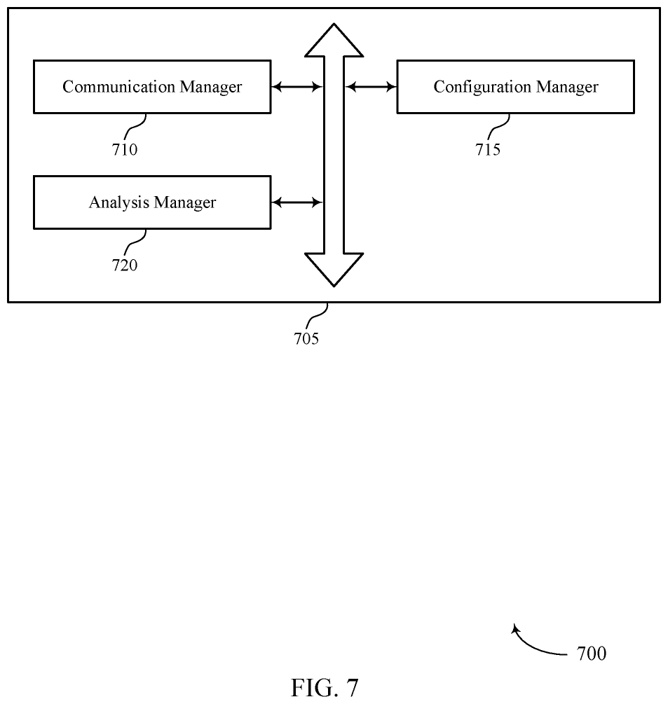

FIG. 7 shows a block diagram 700 of a replay protection manager 705 that supports secure recovery from a replay protection list condition in accordance with aspects of the present disclosure. The replay protection manager 705 may be an example of aspects of a replay protection manager 515, a replay protection manager 615, or a replay protection manager 810 described herein. The replay protection manager 705 may include a communication manager 710, a configuration manager 715, and an analysis manager 720. Each of these modules may communicate, directly or indirectly, with one another (e.g., via one or more buses).

The communication manager 710 may receive, from a first device in a wireless mesh network at a second device in the wireless mesh network, a first message indicating that a replay protection list (RPL) of the first device has reached a defined capacity. In some examples, the communication manager 710 may send, from the second device, a second message indicating at least one of an increase of a capacity of the RPL or a set of source addresses to be included in or removed from the RPL based on determining whether the first device is configured with the fixed RPL or the dynamic RPL.

In some examples, the communication manager 710 may receive, from the first device, an indication that the RPL has been updated based on the second message. In some examples, the communication manager 710 may receive a negative-acknowledgement message from the first device indicating that a capacity of a memory of the first device prevents the increase to the capacity of the RPL.

In some examples, the communication manager 710 may receive an acknowledgement message from the first device indicating that a capacity of a memory of the first device permits the increase to the capacity of the RPL. The configuration manager 715 may determine whether the first device is configured with a fixed RPL or a dynamic RPL based on the first message or a provisioning message received before the first message.

In some examples, the configuration manager 715 may configure the second message to indicate the set of source addresses to be included in a whitelist of the RPL based on determining the first device is configured with the fixed RPL configuration. In some examples, the configuration manager 715 may configure the second message to indicate the set of source addresses to be included in the RPL based on determining the quantity of entries to be excluded from the RPL satisfies the threshold.

In some examples, the configuration manager 715 may configure the second message to indicate the increase to the capacity of the RPL based on determining the quantity of entries to be excluded from the RPL is less than the threshold. In some examples, the configuration manager 715 may configure the second message to indicate the set of source addresses to be included in the whitelist of the RPL based on receiving the negative-acknowledgement message from the first device.

In some examples, the configuration manager 715 may update configuration information of the first device based on the increase to the capacity of the RPL, where the configuration information is stored remotely from the first device. The analysis manager 720 may identify one or more source addresses included in entries of the RPL based on determining the first device is configured with the dynamic RPL configuration, where sending the second message is based on identifying the one or more source addresses.

In some examples, the analysis manager 720 may determine, based on the one or more source addresses indicated in the first message, whether the RPL includes one or more entries to be excluded from the RPL, where sending the second message is based on determining whether the RPL includes one or more entries to be excluded from the RPL. In some examples, the analysis manager 720 may identify a quantity of entries to be excluded from the RPL based on the set of source addresses indicated in the second message. In some examples, the analysis manager 720 may determine whether the quantity of entries to be excluded from the RPL satisfies a threshold.

FIG. 8 shows a diagram of a system 800 including a device 805 that supports secure recovery from a replay protection list condition in accordance with aspects of the present disclosure. The device 805 may be an example of or include the components of device 505, device 605, or a device as described herein. The device 805 may include components for bi-directional voice and data communications including components for transmitting and receiving communications, including a replay protection manager 810, an I/O controller 815, a transceiver 820, an antenna 825, memory 830, and a processor 840. These components may be in electronic communication via one or more buses (e.g., bus 845).

The replay protection manager 810 may receive, from a first device in a wireless mesh network at a second device in the wireless mesh network, a first message indicating that a replay protection list (RPL) of the first device has reached a defined capacity, send, from the second device, a second message indicating at least one of an increase of a capacity of the RPL or a set of source addresses to be included in or removed from the RPL based on determining whether the first device is configured with the fixed RPL or the dynamic RPL, receive, from the first device, an indication that the RPL has been updated based on the second message, and determine whether the first device is configured with a fixed RPL or a dynamic RPL based on the first message or a provisioning message received before the first message.

The I/O controller 815 may manage input and output signals for the device 805. The I/O controller 815 may also manage peripherals not integrated into the device 805. In some cases, the I/O controller 815 may represent a physical connection or port to an external peripheral. In some cases, the I/O controller 815 may utilize an operating system such as iOS®, ANDROID®, MS-DOS®, MS-WINDOWS®, OS/2®, UNIX®, LINUX®, or another known operating system. In other cases, the I/O controller 815 may represent or interact with a modem, a keyboard, a mouse, a touchscreen, or a similar device. In some cases, the I/O controller 815 may be implemented as part of a processor. In some cases, a user may interact with the device 805 via the I/O controller 815 or via hardware components controlled by the I/O controller 815.

The transceiver 820 may communicate bi-directionally, via one or more antennas, wired, or wireless links as described above. For example, the transceiver 820 may represent a wireless transceiver and may communicate bi-directionally with another wireless transceiver. The transceiver 820 may also include a modem to modulate the packets and provide the modulated packets to the antennas for transmission, and to demodulate packets received from the antennas.

In some cases, the wireless device may include a single antenna 825. However, in some cases the device may have more than one antenna 825, which may be capable of concurrently transmitting or receiving multiple wireless transmissions.

The memory 830 may include RAM and ROM. The memory 830 may store computer-readable, computer-executable code 835 including instructions that, when executed, cause the processor to perform various functions described herein. In some cases, the memory 830 may contain, among other things, a BIOS which may control basic hardware or software operation such as the interaction with peripheral components or devices.

The processor 840 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In other cases, a memory controller may be integrated into the processor 840. The processor 840 may be configured to execute computer-readable instructions stored in a memory (e.g., the memory 830) to cause the device 805 to perform various functions (e.g., functions or tasks supporting secure recovery from a replay protection list condition).

The code 835 may include instructions to implement aspects of the present disclosure, including instructions to support secure recovery from full replay protection lists. The code 835 may be stored in a non-transitory computer-readable medium such as system memory or other type of memory. In some cases, the code 835 may not be directly executable by the processor 840 but may cause a computer (e.g., when compiled and executed) to perform functions described herein. In some cases, at least one of device 805, replay protection manager 810, I/O controller 815, transceiver 820, antenna 825, memory 830, code 835, and processor 840 are just some examples of means for performing at least some of the functions described herein.

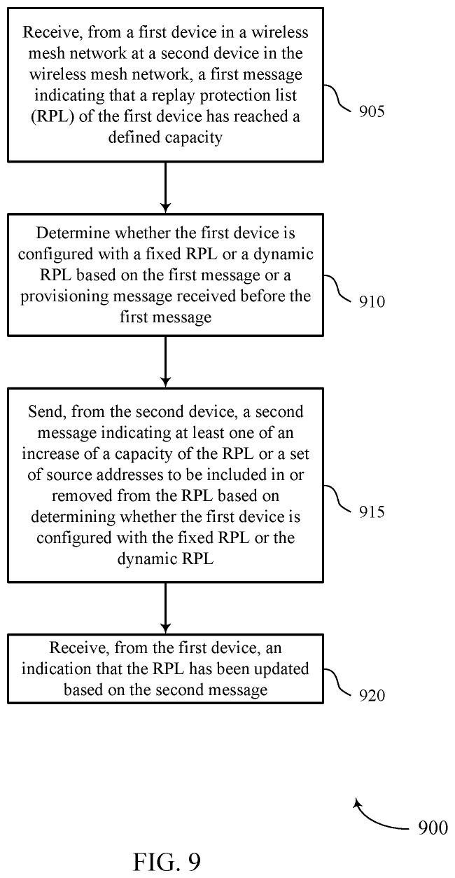

FIG. 9 shows a flowchart illustrating a method 900 that supports secure recovery from a replay protection list condition in accordance with aspects of the present disclosure. The operations of method 900 may be implemented by a device or its components as described herein. For example, the operations of method 900 may be performed by a replay protection manager as described with reference to FIGS. 5 through 8. In some examples, a device may execute a set of instructions to control the functional elements of the device to perform the functions described below. Additionally or alternatively, a device may perform aspects of the functions described below using special-purpose hardware.

At 905, the device may receive, from a first device in a wireless mesh network at a second device in the wireless mesh network, a first message indicating that a replay protection list (RPL) of the first device has reached a defined capacity. The operations of 905 may be performed according to the methods described herein. In some examples, aspects of the operations of 905 may be performed by a communication manager as described with reference to FIGS. 5 through 8.

At 910, the device may determine whether the first device is configured with a fixed RPL or a dynamic RPL based on the first message or a provisioning message received before the first message. The operations of 910 may be performed according to the methods described herein. In some examples, aspects of the operations of 910 may be performed by a configuration manager as described with reference to FIGS. 5 through 8.

At 915, the device may send, from the second device, a second message indicating at least one of an increase of a capacity of the RPL or a set of source addresses to be included in or removed from the RPL based on determining whether the first device is configured with the fixed RPL or the dynamic RPL. The operations of 915 may be performed according to the methods described herein. In some examples, aspects of the operations of 915 may be performed by a communication manager as described with reference to FIGS. 5 through 8.

At 920, the device may receive, from the first device, an indication that the RPL has been updated based on the second message. The operations of 920 may be performed according to the methods described herein. In some examples, aspects of the operations of 920 may be performed by a communication manager as described with reference to FIGS. 5 through 8.

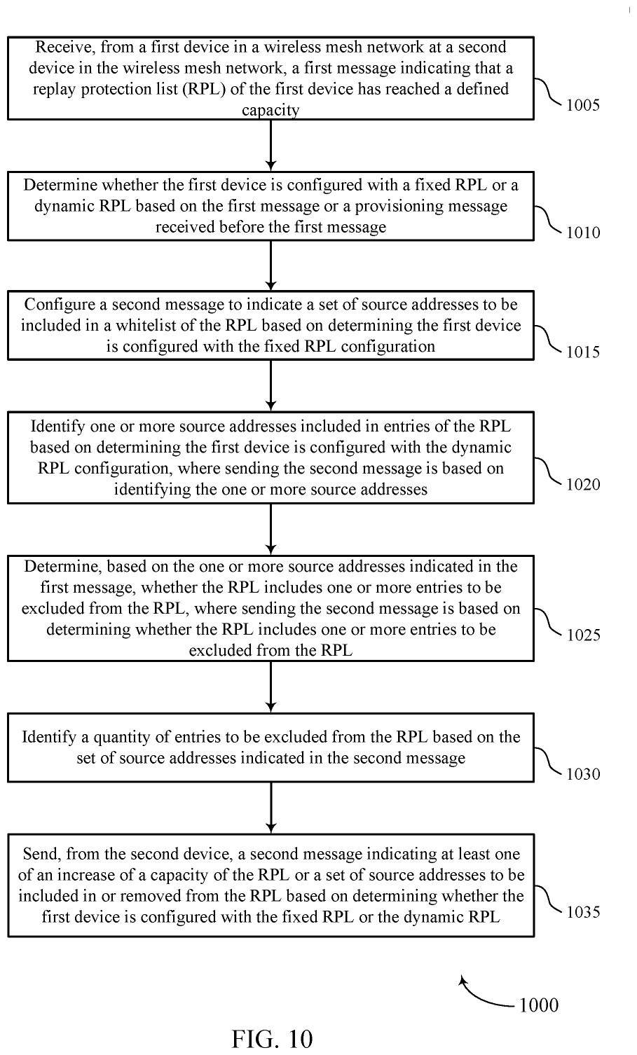

FIG. 10 shows a flowchart illustrating a method 1000 that supports secure recovery from a replay protection list condition in accordance with aspects of the present disclosure. The operations of method 1000 may be implemented by a device or its components as described herein. For example, the operations of method 1000 may be performed by a replay protection manager as described with reference to FIGS. 5 through 8. In some examples, a device may execute a set of instructions to control the functional elements of the device to perform the functions described below. Additionally or alternatively, a device may perform aspects of the functions described below using special-purpose hardware.

At 1005, the device may receive, from a first device in a wireless mesh network at a second device in the wireless mesh network, a first message indicating that a replay protection list (RPL) of the first device has reached a defined capacity. The operations of 1005 may be performed according to the methods described herein. In some examples, aspects of the operations of 1005 may be performed by a communication manager as described with reference to FIGS. 5 through 8.

At 1010, the device may determine whether the first device is configured with a fixed RPL or a dynamic RPL based on the first message or a provisioning message received before the first message. The operations of 1010 may be performed according to the methods described herein. In some examples, aspects of the operations of 1010 may be performed by a configuration manager as described with reference to FIGS. 5 through 8.

At 1015, the device may configure the second message to indicate the set of source addresses to be included in a whitelist of the RPL based on determining the first device is configured with the fixed RPL configuration. The operations of 1015 may be performed according to the methods described herein. In some examples, aspects of the operations of 1015 may be performed by a configuration manager as described with reference to FIGS. 5 through 8.

At 1020, the device may identify one or more source addresses included in entries of the RPL based on determining the first device is configured with the dynamic RPL configuration, where sending the second message is based on identifying the one or more source addresses. The operations of 1020 may be performed according to the methods described herein. In some examples, aspects of the operations of 1020 may be performed by an analysis manager as described with reference to FIGS. 5 through 8.

At 1025, the device may determine, based on the one or more source addresses indicated in the first message, whether the RPL includes one or more entries to be excluded from the RPL, where sending the second message is based on determining whether the RPL includes one or more entries to be excluded from the RPL. The operations of 1025 may be performed according to the methods described herein. In some examples, aspects of the operations of 1025 may be performed by an analysis manager as described with reference to FIGS. 5 through 8.

At 1030, the device may identify a quantity of entries to be excluded from the RPL based on the set of source addresses indicated in the second message. The operations of 1030 may be performed according to the methods described herein. In some examples, aspects of the operations of 1030 may be performed by an analysis manager as described with reference to FIGS. 5 through 8.

At 1035, the device may send, from the second device, a second message indicating at least one of an increase of a capacity of the RPL or a set of source addresses to be included in or removed from the RPL based on determining whether the first device is configured with the fixed RPL or the dynamic RPL. The operations of 1035 may be performed according to the methods described herein. In some examples, aspects of the operations of 1035 may be performed by a communication manager as described with reference to FIGS. 5 through 8.

It should be noted that the methods described herein describe possible implementations, and that the operations and the steps may be rearranged or otherwise modified and that other implementations are possible. Further, aspects from two or more of the methods may be combined.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an application-specific integrated circuit (ASIC), a field-programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may include random-access memory (RAM), read-only memory (ROM), electrically erasable programmable read only memory (EEPROM), flash memory, compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for secure recovery from full replay protection lists, comprising:
receiving, from a first device in a wireless mesh network at a second device in the wireless mesh network, a first message indicating that a replay protection list (RPL) of the first device has reached a defined capacity;
determining whether the first device is configured with a fixed RPL or a dynamic RPL based at least in part on the first message or a provisioning message received before the first message;
sending, from the second device, a second message indicating at least one of an increase of a capacity of the RPL or a set of source addresses to be included in or removed from the RPL based at least in part on determining whether the first device is configured with the fixed RPL or the dynamic RPL; and
receiving, from the first device, an indication that the RPL has been updated based at least in part on the second message.

2. The method of claim 1, further comprising:
configuring the second message to indicate the set of source addresses to be included in a whitelist of the RPL based at least in part on determining the first device is configured with the fixed RPL configuration.

3. The method of claim 1, further comprising:
identifying one or more source addresses included in entries of the RPL based at least in part on determining the first device is configured with the dynamic RPL configuration, wherein sending the second message is based at least in part on identifying the one or more source addresses.

4. The method of claim 3, further comprising:
determining, based at least in part on the one or more source addresses indicated in the first message, whether the RPL includes one or more entries to be excluded from the RPL, wherein sending the second message is based at least in part on determining whether the RPL includes one or more entries to be excluded from the RPL.

5. The method of claim 4, further comprising:
identifying a quantity of entries to be excluded from the RPL based at least in part on the set of source addresses indicated in the second message; and
determining whether the quantity of entries to be excluded from the RPL satisfies a threshold.

6. The method of claim 5, further comprising:
configuring the second message to indicate the set of source addresses to be included in the RPL based at least in part on determining the quantity of entries to be excluded from the RPL satisfies the threshold.

7. The method of claim 5, further comprising:
configuring the second message to indicate the increase to the capacity of the RPL based at least in part on determining the quantity of entries to be excluded from the RPL is less than the threshold.

8. The method of claim 7, further comprising:
receiving a negative-acknowledgement message from the first device indicating that a capacity of a memory of the first device prevents the increase to the capacity of the RPL.

9. The method of claim 8, further comprising:
configuring the second message to indicate the set of source addresses to be included in the whitelist of the RPL based at least in part on receiving the negative-acknowledgement message from the first device.

10. The method of claim 7, further comprising:
receiving an acknowledgement message from the first device indicating that a capacity of a memory of the first device permits the increase to the capacity of the RPL; and
updating configuration information of the first device based at least in part on the increase to the capacity of the RPL, wherein the configuration information is stored remotely from the first device.

11. An apparatus for secure recovery from full replay protection lists, comprising:
a processor,
memory in electronic communication with the processor; and
instructions stored in the memory and executable by the processor to cause the apparatus to:
receive, from a first device in a wireless mesh network at the apparatus in the wireless mesh network, a first message indicating that a replay protection list (RPL) of the first device has reached a defined capacity;
determine whether the first device is configured with a fixed RPL or a dynamic RPL based at least in part on the first message or a provisioning message received before the first message;
send, from the apparatus, a second message indicating at least one of an increase of a capacity of the RPL or a set of source addresses to be included in or removed from the RPL based at least in part on determining whether the first device is configured with the fixed RPL or the dynamic RPL; and
receive, from the first device, an indication that the RPL has been updated based at least in part on the second message.

12. The apparatus of claim 11, wherein the instructions are further executable by the processor to cause the apparatus to:
configure the second message to indicate the set of source addresses to be included in a whitelist of the RPL based at least in part on determining the first device is configured with the fixed RPL configuration.

13. The apparatus of claim 11, wherein the instructions are further executable by the processor to cause the apparatus to:
identify one or more source addresses included in entries of the RPL based at least in part on determining the first device is configured with the dynamic RPL configuration, wherein sending the second message is based at least in part on identifying the one or more source addresses.

14. The apparatus of claim 13, wherein the instructions are further executable by the processor to cause the apparatus to:
determine, based at least in part on the one or more source addresses indicated in the first message, whether the RPL includes one or more entries to be excluded from the RPL, wherein sending the second message is based at least in part on determining whether the RPL includes one or more entries to be excluded from the RPL.

15. The apparatus of claim 14, wherein the instructions are further executable by the processor to cause the apparatus to:
identify a quantity of entries to be excluded from the RPL based at least in part on the set of source addresses indicated in the second message; and
determine whether the quantity of entries to be excluded from the RPL satisfies a threshold.

16. The apparatus of claim 15, wherein the instructions are further executable by the processor to cause the apparatus to:
configure the second message to indicate the set of source addresses to be included in the RPL based at least in part on determining the quantity of entries to be excluded from the RPL satisfies the threshold.

17. The apparatus of claim 15, wherein the instructions are further executable by the processor to cause the apparatus to:
configure the second message to indicate the increase to the capacity of the RPL based at least in part on determining the quantity of entries to be excluded from the RPL is less than the threshold.

18. The apparatus of claim 17, wherein the instructions are further executable by the processor to cause the apparatus to:
receive a negative-acknowledgement message from the first device indicating that that a capacity of a memory of the first device prevents the increase to the capacity of the RPL.

19. The apparatus of claim 18, wherein the instructions are further executable by the processor to cause the apparatus to:
configure the second message to indicate the set of source addresses to be included in the whitelist of the RPL based at least in part on receiving the negative-acknowledgement message from the first device.

20. An apparatus for secure recovery from full replay protection lists, comprising:
means for receiving, from a first device in a wireless mesh network at the apparatus in the wireless mesh network, a first message indicating that a replay protection list (RPL) of the first device has reached a defined capacity;
means for determining whether the first device is configured with a fixed RPL or a dynamic RPL based at least in part on the first message or a provisioning message received before the first message;
means for sending, from the apparatus, a second message indicating at least one of an increase of a capacity of the RPL or a set of source addresses to be included in or removed from the RPL based at least in part on determining whether the first device is configured with the fixed RPL or the dynamic RPL; and
means for receiving, from the first device, an indication that the RPL has been updated based at least in part on the second message.
